(19) United States
(12) Patent Application Publication
(10) Pub. No.: US 2006/0161982 A1
(43) Pub. Date: Jul. 20, 2006

(54) Intrusion detection system

(76) Inventors: Suresh N. Chari, Scarsdale, NY (US); Pau-Chen Cheng, Yorktown Heights, NY (US); Josyula R. Rao, Briarcliff Manor, NY (US); Pankaj Rohatgi, New Rochelle, NY (US); Michael Steiner, New York, NY (US)

Correspondence Address: LAW OFFICE OF CHARLES W. PETERSON, JR. Yorktown, 11703 BOWMAN GREEN DRIVE, SUITE 100, RESTON, VA, 20190, US

(21) Appl. No.: 11/037,695

(22) Filed: Jan. 18, 2005

(51) Int. Cl. G06F 12/14

(52) U.S. Cl. 726/23

(57) ABSTRACT

An intrusion detection system (IDS), method of protecting computers against intrusions and program product therefor. The IDS determines which applications are to run in native environment (NE) and places the remaining applications in a sandbox. Some of the applications in sandboxes may be placed in a personalized virtual environment (PVE) in the sandbox. Upon detecting an attempted attack, a dynamic honeypot may be started for an application in a sandbox and not in a PVE. A virtualized copy of system resources may be created for each application in a sandbox and provided to the corresponding application in the respective sandbox.

### FIELD OF THE INVENTION

The present invention is related to Intrusion Detection Systems (IDS) and particularly to IDSs that detect and isolate malicious attacks on computer systems.

### BACKGROUND DESCRIPTION

Computer security has become a major concern. The FBI has recognized cyber-terrorism as its number 3 priority in protecting the U.S. from terrorist threats. See, e.g., “Cyber Terrorism,” Testimony of Keith Lourdeau, Deputy Assistant Director, Cyber Division, FBI, Before the Senate Judiciary Subcommittee on Terrorism, Technology, and Homeland Security (www.fbi.gov/congress/congress04/lourdeau022404.htm), Feb. 24, 2004. An attack on a computer system or on a virtual machine (VM) running within the system (whether cyber terror or not) is an intentional and malicious act (or code) that tries to gain access to certain resources on the system in a way that is not intended by the system's security policy. A successful attack usually exploits defects in an application program, defects in the security policy, or both. For example, an attacker may take control of an application program that has special privileges for accessing resources. By exploiting defects in the program, the attacker can access resources using the program's special privileges, even though system security policies or the application itself may normally prevent such accesses.

An attack usually is characterized by a signature, e.g., characteristic steps that constitute the exploitation, data that the attack sends to the application, the target of the attack and etc. One well-known attack is a worm. A typical worm inserts code into an attacked computer system, e.g., piggy backing on an e-mail or spam. Then, the worm causes the inserted code to be executed on the attacked system. The attacked system repeats the attack against other computer systems, e.g., sending out emails to everyone listed in a local address book. So, the worm copies and spreads itself from one computer to another. Other types of well-known attacks include “Trojan Horses” and Denial of Service (DOS) attacks.

All of these attacks, at the very least, waste valuable resources. A typical worm, for example, wastes computer system time, storing itself, executing, generating copies and forwarding those copies to other computers. Sufficient volume of e-mails from such a worm may slow traffic and clog an e-mail server for, in effect, a denial of service. While extra e-mails, slow web response times and/or the inability to surf certain sites may be an annoyance for the typical cyber surfer; these same results on a mission critical computer may prove disastrous. Locking an air traffic control system or a nuclear power plant control system, for example, could result in serious consequential damage. With more and more systems connected to the Internet, the likelihood of such a disaster is becoming increasingly likely.

However, stopping cyber attack as they occur and before they can cause any damage, is only a half measure. Once an attack is identified, sufficient data must be collected about the attack to determine the origin of the attack, modes of operation and intention of the attacks, to facilitate identification of attack signatures, to identify the particular methods of spreading (e.g., for worm attacks) and etc. As Director Lourdeau noted, however, collecting such data can be extremely difficult and requires “research and development involving basic security, such as developing cryptographic hardware which will serve to filter attempts to introduce malicious code or to stop unauthorized activity. Continued research in these areas will only serve to assist the FBI in its work against cyberterrorism.”

Thus, there is a need for tight computer security that adequately filters attempts to introduce malicious code, stops unauthorized activity before damage occurs and collects data for analyzing attacks.

### SUMMARY OF THE INVENTION

It is a purpose of the invention to protect computer resources from attacks;

It is another purpose of the invention to minimize wasted resources in computers protected against attacks;

It is another purpose of the invention to collect data on malicious attacks to computer systems.

The present invention relates to an intrusion detection system (IDS), method of protecting computers against intrusions and program product therefor. The IDS determines which applications are to run in native environment (NE) and places the remaining applications in a sandbox. Some of the applications in sandboxes may be placed in a personalized virtual environment (PVE) in the sandbox. Upon detecting an attempted attack, a dynamic honeypot may be started for an application in a sandbox and not in a PVE. A virtualized copy of system resources may be created for each application in a sandbox and provided to the corresponding application in the respective sandbox.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a flow diagram of a preferred embodiment method of protecting computers against malicious attacks according to the present invention;

FIG. 2 show examples of a computer running an application in native environment;

FIG. 3 shows an example of the computer running an application in a virtual machine or VM initiated in step with like elements labeled identically;

FIGS. 4A-B show before and after examples of a preferred computer wherein an application running in a sandbox has restricted access to resources and is the subject of an attack;

FIG. 4C shows a multi-tasking example of the same computer;

FIGS. 5A-B show an example of starting an application in FIG. 1 in more detail;

FIG. 6 shows an example of the steps of requesting resources and handling the requests in FIG. 1 in more detail;

FIGS. 7A-B show an example of virtualizing resources for a requesting application in a PVE and providing the virtualized resources;

FIG. 8A shows an example opening a dynamic honeypot, if necessary;

FIG. 8B shows an example of providing virtualized resources to an application in a dynamic honeypot contained within a sandbox;

FIG. 9 shows an example of constructing a dynamic honeypot in the sandbox around the application when more than one honeypot plan may have been pre-defined.

### DESCRIPTION OF PREFERRED EMBODIMENTS

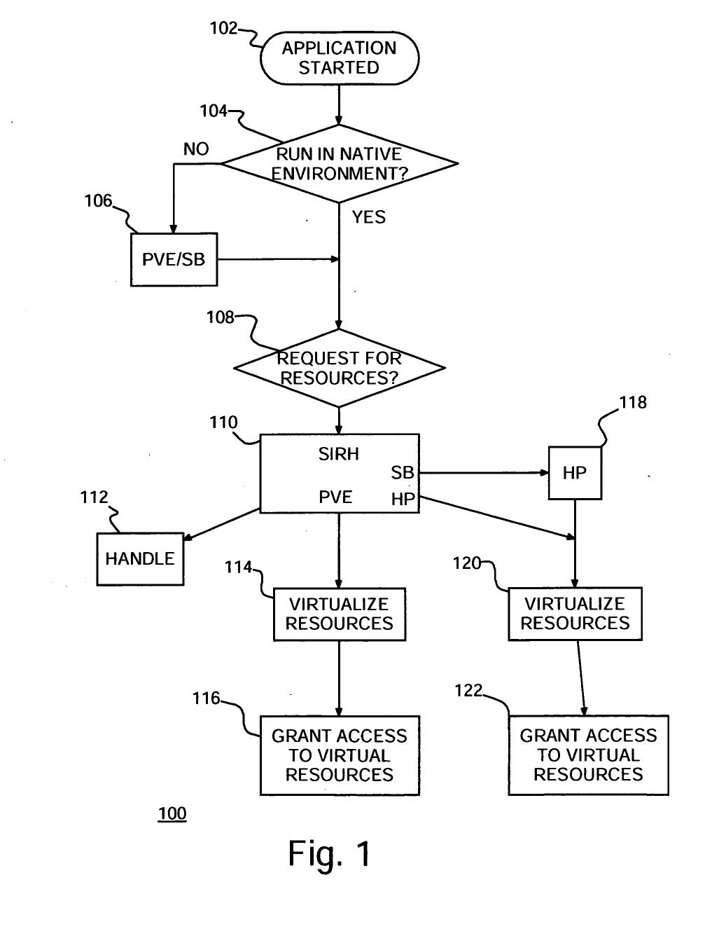

Turning now to the drawings and more particularly FIG. 1 shows an example of a flow diagram 100 of a preferred embodiment method of protecting computers against malicious attacks according to the present invention. In particular, as each application starts in 102, the starting application is checked in step 104 to determine whether it may safely run directly by the operating system (OS) in what is known as Native Environment (NE). For purposes of discussion herein, a computer or computer system refers to a collection of hardware and software resources, such as processors, memory, disk storage, executable, programs, files, input/output devices, network interfaces, etc., cooperatively performing computing tasks. The operating system manages computer operation, mediates and controls access to the computer and, ensures fair and adequate use of computer resources by application programs or, simply, applications. If in step 104 the application is not to run in NE, then in step 106 a contained environment is created for the application. So at this point, a rigid behavior boundary, known as a SandBox (SB), may be erected around the application to prohibit or limit external (to the application) resources, e.g., by intercepting system calls. Any attempt to violate the SB boundary is considered an intrusion. Additionally, the computer system may be partitioned into one of more “Virtual Machines” (VM) by a “Virtual Machine Monitor” (VMM). Each virtual machine is allocated a subset of the system resources and functions as a self-contained computer system, running an instance of an Operating System in its own environment. For an OS inside a virtual machine, the virtual machine looks like any normal individual computer system. Since a virtual machine functions like an individual computer system, a VMM may be running inside a VM that was itself created by another VMM.

Then, the application opens in NE, a Personal Virtualized Environment (PVE) or a SB and operates normally, waiting in step 108 until the application initiates a request for external (to the application) resources, e.g., through a system call. Once an application requests external resources, then continuing to step 110, a System call interceptor, Intrusion detection, Resource access control/switch, Honeypot/illusion generator (SIRH) intercepts the system call and determines the correct response. If the SIRH determines that the application is operating in native environment and that the request does not present a threat, then in step 112, the system handles the request normally. Otherwise, the SIRH recognizes that the system call could, potentially, be an attack and must be treated accordingly.

If in step 108 the requesting application is running in a PVE, then in step 114 the SIRH virtualizes the requested resources, e.g., by creating a virtual copy of the requested resources. In step 116 the requesting application is granted access to the virtual resources within the PVE. However, if in step 108 the requesting application is contained in a sandbox, the SIRH opens a virtualized environment known as a honeypot in step 118 and places the application in the newly opened dynamic honeypot. Essentially, the honeypot virtualized environment appears to the application and, correspondingly, to any attack launched through the application, as though the application is operating in NE. Thus, the dynamic honeypot requires all typical computer system resources. Once in the dynamic honeypot in step 118 or, if in step 110 the requesting application is already operating in a dynamic honeypot, then in step 120 the requested resources are virtualized, e.g., by creating a virtual copy of the requested resources. In step 122 the requesting application is granted access to the virtual resources within the dynamic honeypot. Thus, advantageously, the present invention minimizes the overhead for continuously operating a honeypot, while continuing to protect potentially vulnerable applications and resources with little, if any, apparent impact on the application.

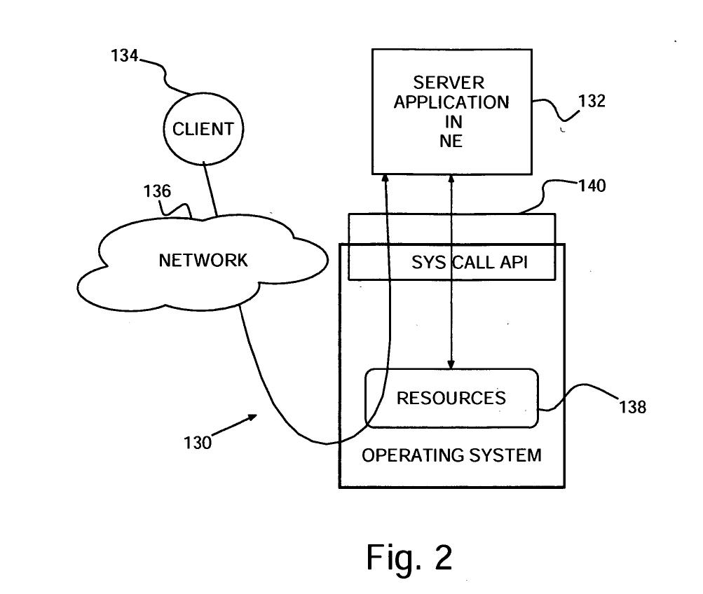

FIG. 2 shows an example of a computer 130 running an application 132 in native environment. A client 134 (e.g., a remote computer) communicates with the computer 130 over a typical communications network 136, e.g., a Local Area Network (LAN) or the Internet. So, in a preferred embodiment computer 130, applications 132 operating in NE, operate substantially unchanged. Communications pass from the client 134 to the application 132. In response to a request for resources in step 108 of FIG. 1, the application 132 receives controlled access to system resources 138 under OS supervision, which exports a well-defined application programming interface (or API). The application 132 runs on top of the OS and accesses system resources 138 by making function calls. These function calls are called system calls (or syscall) and the API is called the system call API (syscall API) 140.

The OS treats each system call made by the application 132 as a request to access certain resources in certain “access modes,” e.g., read, write, delete, create and etc. The OS can either grant or deny each request according to the system's security policy. The security policy defines access-control rules to resources and provides restricted resource access to the application 132. These access-control rules may be defined in terms of application attributes, requested access modes, resource attributes, environmental parameters, and etc. Application attributes may include, for example, application privileges, the identity of the user on behalf of which the application is being executed and, etc. The requested access mode includes, for example, read or write access. Resource attributes may include, for example, the identities of the resource owners, allowed resource access modes and, etc. Environmental parameters may include, for example, time of day and, etc. Normally, the system call API 140 is the one and only entry point (or gate) through which the resources 138 can be accessed and each such access attempt is controlled by the security policy. Also, normally, the syscall API 140 is the only interface through which an application program can get a view of the system.

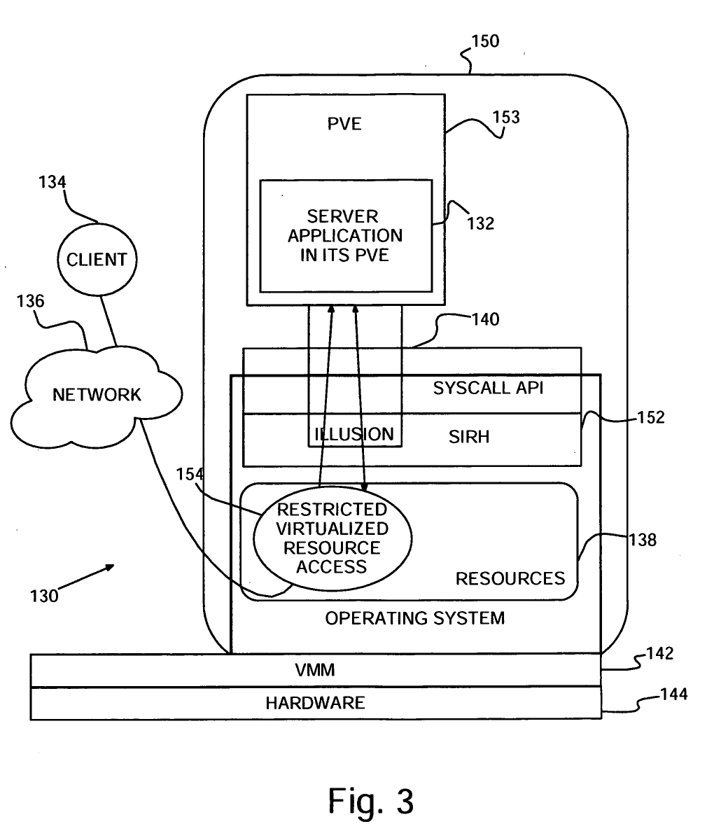

FIG. 3 shows an example of the computer 130 of FIG. 2 (with like elements labeled identically) running the application 132 in a virtual machine or VM 150, created and monitored by VMM 142, and operating inside system hardware 144. Typically, the VM 150 houses an instance of the OS and one or more particular applications (132 in this example) running on top of the OS with the SIRH 152 active. Further in this example, the application 132 is running a virtual environment that is personalized for the particular application, i.e., in a PVE 153. It should be noted that the VM 150 may be created through the VMM 142 in step 106 just to house the PVE 153. Further, although a single VM 150 is shown running on top of VMM 142 in this example, this is for example only and other VMs (not shown in this example) may be running on the VMM 142, each with an instance of an OS and one or more PVEs or dynamic honeypots. Also although in this example the VMM 142 is shown running on top of the system hardware 144, this is for example only and there is no intended restriction for VMM 142 implementation. The VMM 142 may be implemented in any other suitable manner, e.g., the OS may be running on top of the hardware 144 and the VMM 142 running inside the OS creating and managing VMs. The OS may be further operating within another VM.

Each partition 150 acts as a single independent system and with independently running applications 132 active in the partition 150. Normally, the OS and resident applications 132 function in the VM 150 as if they were on an independent computer with exclusive use of computer system resources 138. So, both the OS and applications 132 in one partition 150 may be different from other partitions. When the client 134 communicates with the application 132, the application 132 may request resources e.g., through a function call. The SIRH 152 intercepts calls from the application 132 in step 110 of FIG. 1 and, upon determining that the PVE requires the requested resources 138 to be virtualized, in step 114 the SIRH 152 creates a virtual copy 154 of the requested resources 138. Then, the SIRH 152 grants access to the virtualized resources 154 in step 116.

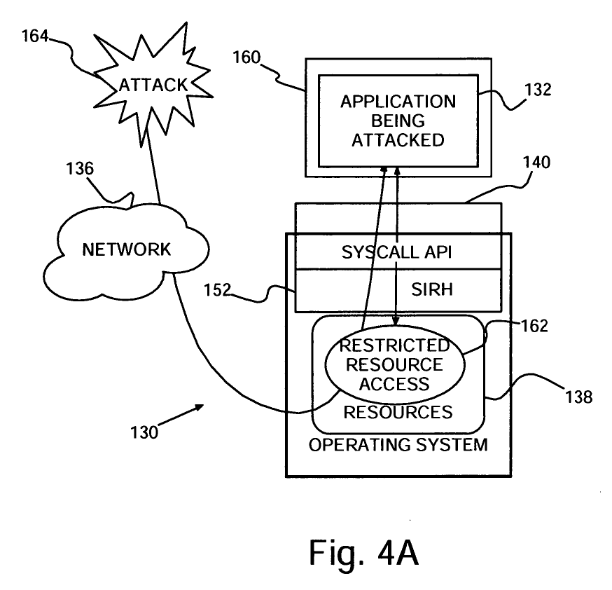

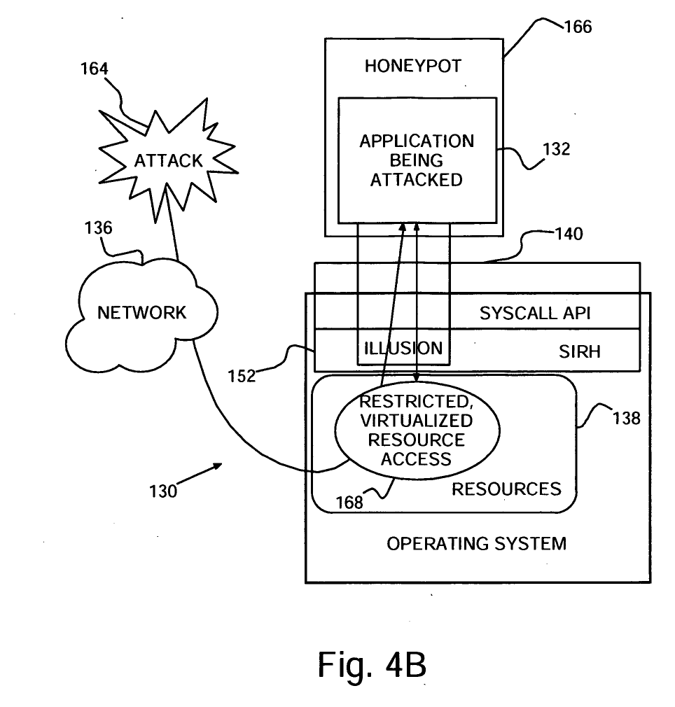

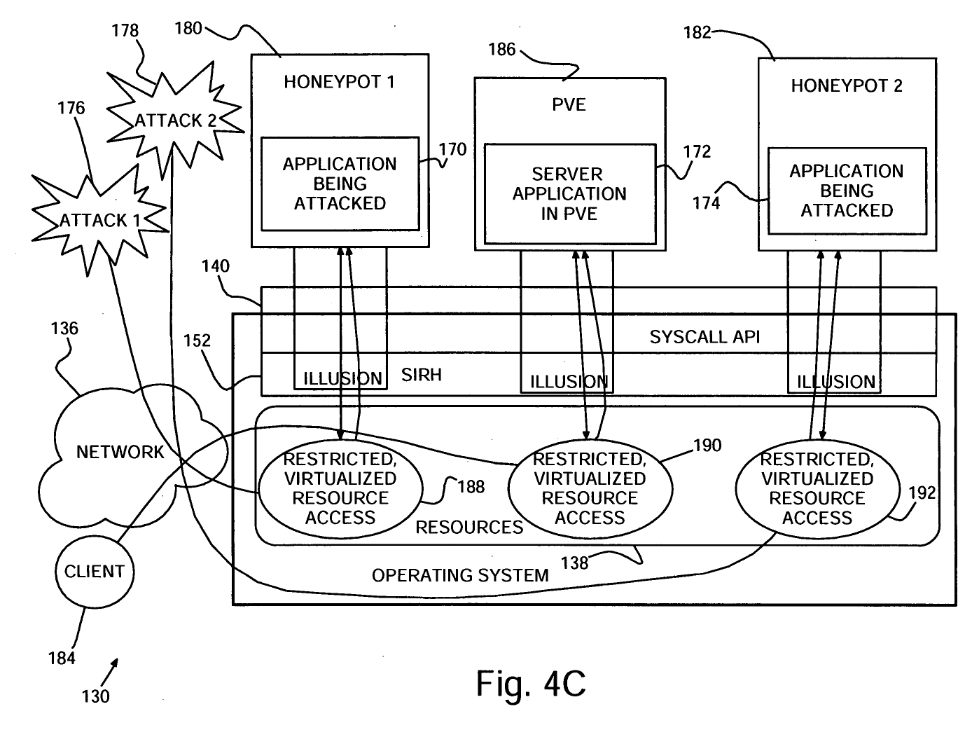

FIGS. 4A-B show before and after examples of a preferred computer 130 wherein an application running in a sandbox 160 has restricted access to resources 162 and is the subject of an attack 164. FIG. 4C shows a multi-tasking example of the same computer 130. A sandbox 160 is considered an Intrusion Detection System (IDS). An IDS monitors and/or examines the behavior of active programs to detect malicious intrusions into system resources, e.g., 138. Typical such IDSs also include Misuse Detection IDSs, Anomaly Detection IDSs, as well as honeypots. The sandbox 160 is implemented on top of a well-defined API, the system call API 140. Since the system call API 140 under security policy control is the one and only entry point (or gate) through which system resources can be accessed, it is the only interface through which an application can view the system and access resources. So, by monitoring system calls to the API 140, suspicious activity can be identified and contained. Thus, in step 106 of FIG. 1, the sandbox 160 may be implemented as code inserted in to the system call API 140 to enforce the security policy for the particular application to control the application's access to system resources and confine application behaviors. The typical sandbox 160 is a very low overhead IDS, requiring only security policy changes and, perhaps some additional code. Notably, the sandbox 160 can normally very accurately identify, block and stop attacks in action and as detected. Usually, sandboxes 160 have low false alarm (false positive) rates and low false negative rates. Previously, however, while blocking the attack in a prior art sandbox might have protected the particular computer or computer resources, it did not collect much useful information, if any. Such information might be used for improving system integrity and anticipating future attacks.

By contrast, the SIRH 152 allows the attack to proceed in a quarantined environment so that each attack can be monitored collecting data (attack signatures or attack statistics) for subsequent attack identification. So, in this example, the SIRH 152 intercepts calls from the application 132 in step 110 of FIG. 1 and, upon identifying the possibility of an attack 164 (and because the application 132 is not in a PVE), opens a dynamic honeypot 166 inside the sandbox 160 in step 118. Like any typical state of the art honeypot, the dynamic honeypot 166 emulates system behavior, providing a realistic image of a target of interest and an illusion of successful attacks. Since normally operating applications do not act in such a way as to be attracted to or be lured into a honeypot; any attempt to access the dynamic honeypot's resources 138 in a way that is inconsistent with the expected behavior of a normally operating application 132, most likely, is an attack. So, in step 120, as an action of the dynamic honeypot 166, the SIRH 152 creates a virtual copy 168 of restricted resources,.i.e., the part of resources 138 being requested. Then, the SIRH 152 grants access to the virtual copy 168, creating the illusion that the attack 164 is successful, while the resources 138 are still protected. With the application 132 running in the dynamic honeypot 166, grants access to the restricted virtualized resources 168 in step 122.

Advantageously, system resources are not consumed by a honeypot until a dynamic honeypot 166 is started. This is a significant advantage over a state of the art honeypot that constantly consumes resources that may divert some attacks from other systems to itself, but cannot catch attacks mounted against other computer systems. Further, attacks 164 on a preferred embodiment system proceed under the illusion that they have successfully invaded the system; and, because they are isolated within the system, may be observed safely without damaging system resources 138. Thus, the present invention identifies activity that indicates an attack 162 may be eminent and forgoes starting a dynamic honeypot 166, until such an eminent attack 162 is recognized. Additionally, the dynamic honeypot 166 consumes no part of the system resources 138 until the dynamic honeypot 166 is opened and system resources are so dedicated for the dynamic honeypot 166, i.e., only when the need arises. Thereafter, a preferred dynamic honeypot 166 may monitor and collect attack information for analysis and subsequent protection.

Similarly, in the multi-tasking example of FIG. 4C, individual applications 170, 172, 174 are active and running in parallel, independently of each other. Applications 170, 174, which are being attacked by attacks 176, 178, are operating in previously constructed dynamic honeypots 180, 182. A client 184 is communicating with application 172, which is operating in a PVE 186. Since each application 170, 172, 174 has requested access to resources 138 through a system call API 140, the SIRH 152 intercepted the calls, and in this example, created virtualized resources 188, 190, 192 and granted each application 170, 172, 174 access to the respective virtualized resources 188, 190, 192. Thus, each application 170, 172, 174 operates on its own virtualized resources 188, 190, 192, independent of and unhindered by other active applications. Further, the SIRH 152 can monitor responses from each application 170, 174 to its respective attacks 176, 178, e.g., for subsequent study. Even as these attacks 176, 178, are allowed to ravage the virtualized resources 188, 192, system resources 138 remain protected and uninterrupted.

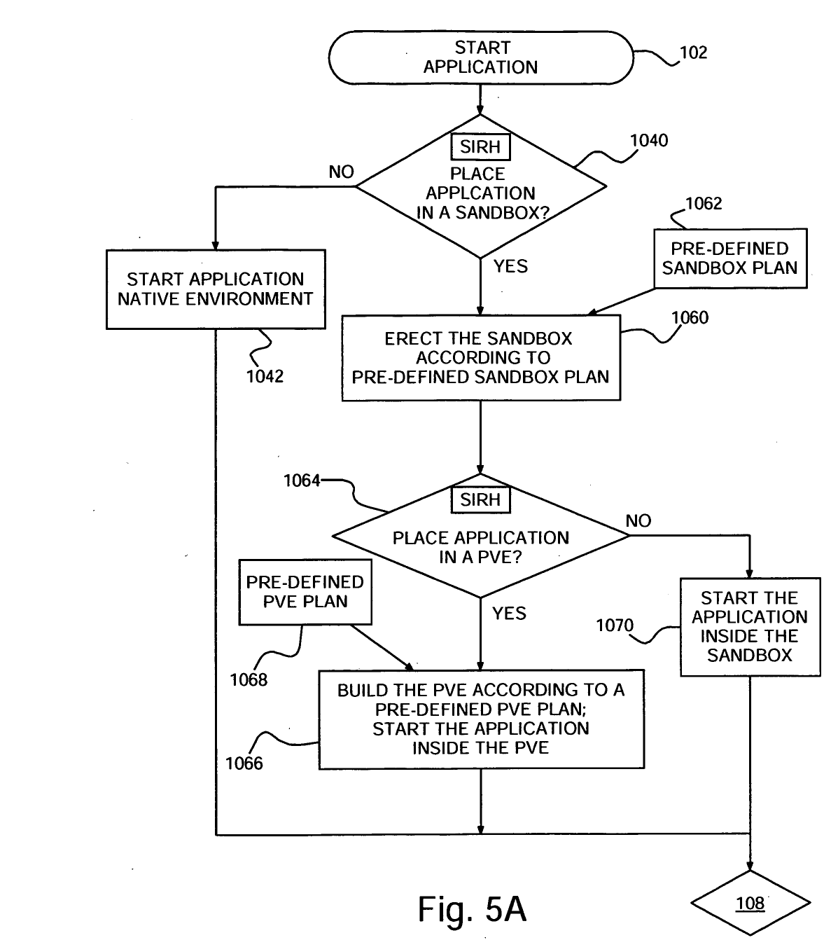

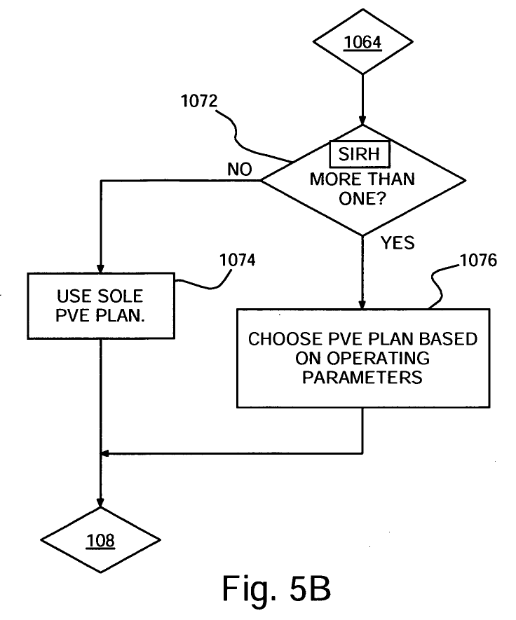

FIGS. 5A-B show an example of starting an application (e.g., 132) as in steps 102-106 of FIG. 1 in more detail. When the application starts in step 102, the SIRH determines in step 1040 whether it should run in a native environment in 1042. If so, it is placed in native environment 1042 and passed to step 108 where it operates normally. Otherwise, in step 1060 a predefined sandbox plan 1062 may be retrieved and erected around the application. Next, in step 1064, a determination is made whether the application should be run in a PVE. If so, a PVE is constructed in step 1066, preferably, based on a predefined PVE plan 1068. Once the application is placed in the PVE, it is passed to step 108 where it operates normally within the PVE. Otherwise, the application begins running inside the sandbox in step 1070 and then, is passed to step 108 where it operates normally within the sandbox.

Optionally, when there may be more than one PVE plan 1068, a single PVE may be selected as shown in the example of FIG. 5B. In step 1072, pre-defined PVE plans 1068 are checked to determine if more than one exist. If not, in step 1074, the single pre-defined plan is selected and passed to step 108. Otherwise, in step 1076, one of the available pre-defined PVE plans 1068 is selected. Preferably, a PVE plan is selected based on certain parameters that may include but are not limited to: the application program identity; environmental parameters such as time of day; attributes of the application such as the identity of the user on behalf of which the application is being executed; the intended usage of the application; the identity of the computer system on which the application is to run; and etc. The selected plan is passed to step 108.

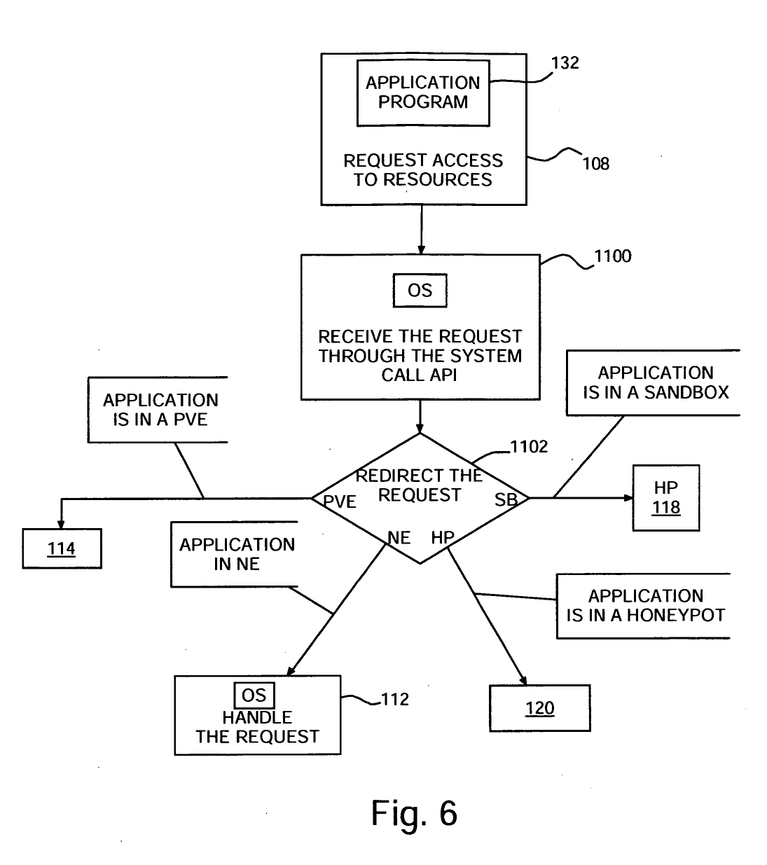

FIG. 6 shows an example of the steps of requesting resources 108 and handling the requests 110 in FIG. 1 in more detail. So, in step 108 an application requests resources by making a system call. The operating system receives the request through a system call API in step 1100. In step 1102 the SIRH intercepts the request and selects the correct response based upon the requesting application's current operating environment. So, if the requesting application is not in a PVE or a sandbox or has not already been placed in a dynamic honeypot, it is operating in NE and, in step 112 the OS handles the request. Otherwise, if the application is in a PVE it is passed to step 114; if the application is operating in a sandbox, it is passed to step 118 where a dynamic honeypot may be opened around the application; or else, it is already in a dynamic honeypot and passed to step 120.

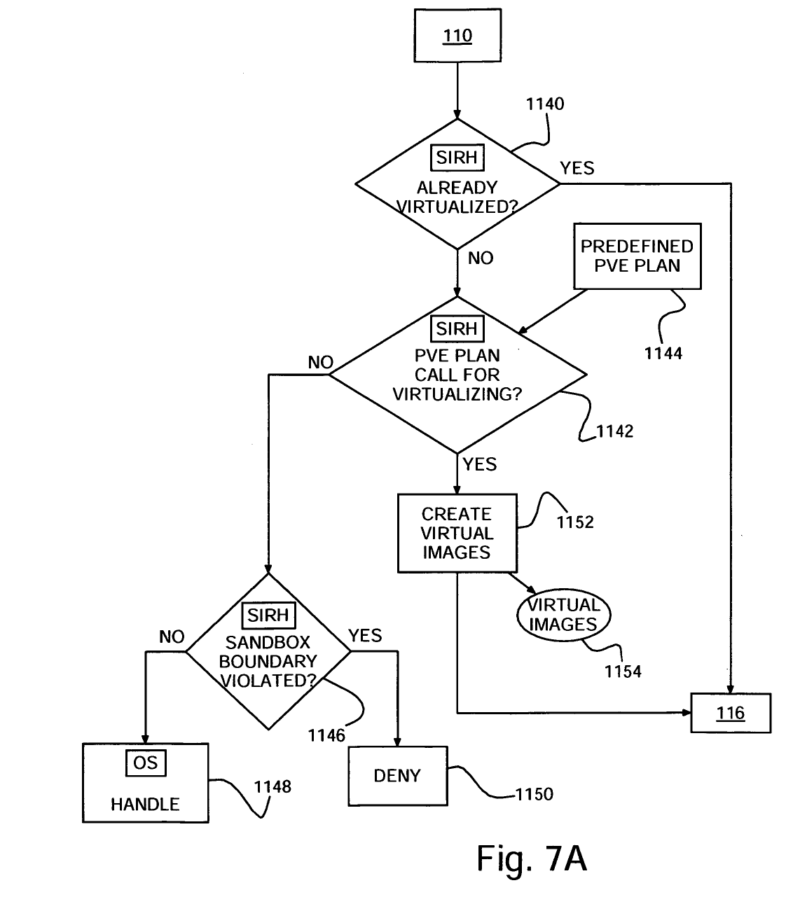

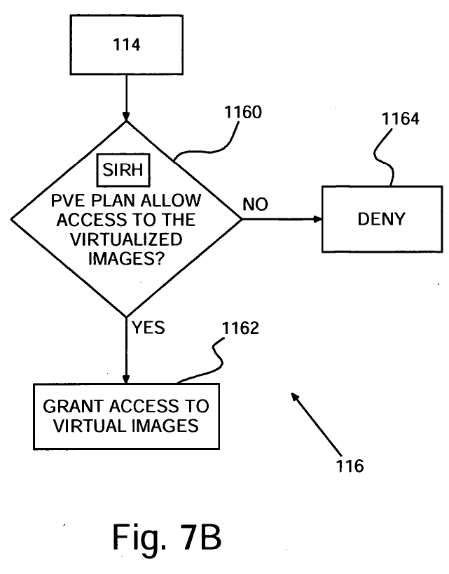

FIGS. 7A-B show an example of virtualizing resources for a requesting application in a PVE in step 114 and granting access to the virtualized resources in step 116. First in step 1140, the SIRH 152 checks to determine whether the requested resources have already been virtualized. If not, in step 1142 the SIRH 152 checks the PVE plan 1144 to determine whether the requested resources should be virtualized. If not, the SIRH 152 checks whether the request violates the sandbox boundary in step 1146 and, if not, allows the OS to handle the request in 1148. Otherwise in step 1150, the SIRH 152 denies the request. If in step 1142, however, the SIRH 152 determines that the requested resources should be virtualized, then in step 1152 a virtual image 1154 is created of the requested resources. If it was determined in step 1140 that resources head already been virtualized, that image is used as virtualized image 1154. Finally in step 1160, the SIRH 152 determines whether the PVE plan 1144 allows access to the virtualized image 1154 and, if so, grants access in step 1162. Otherwise, in step 1164, the SIRH 152 denies access.

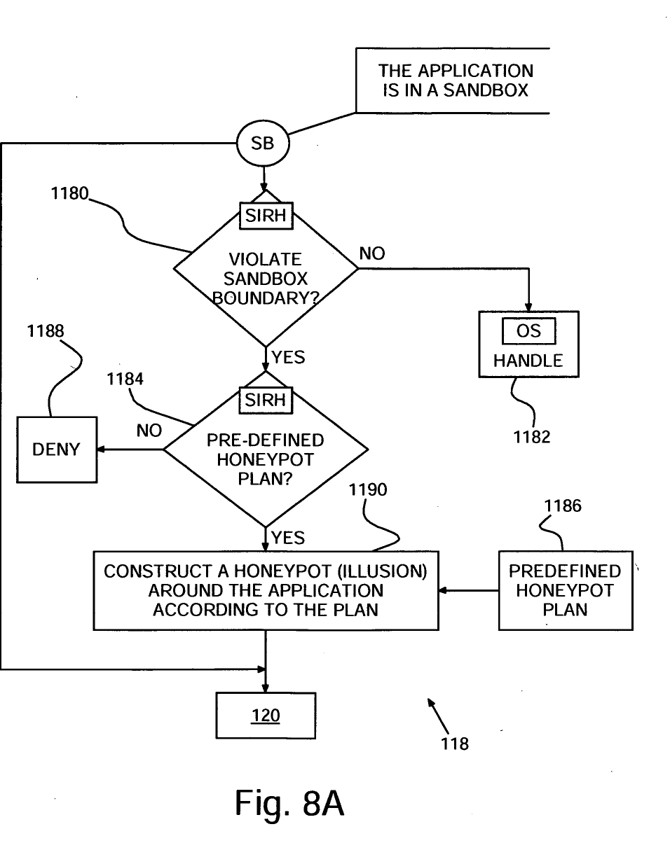

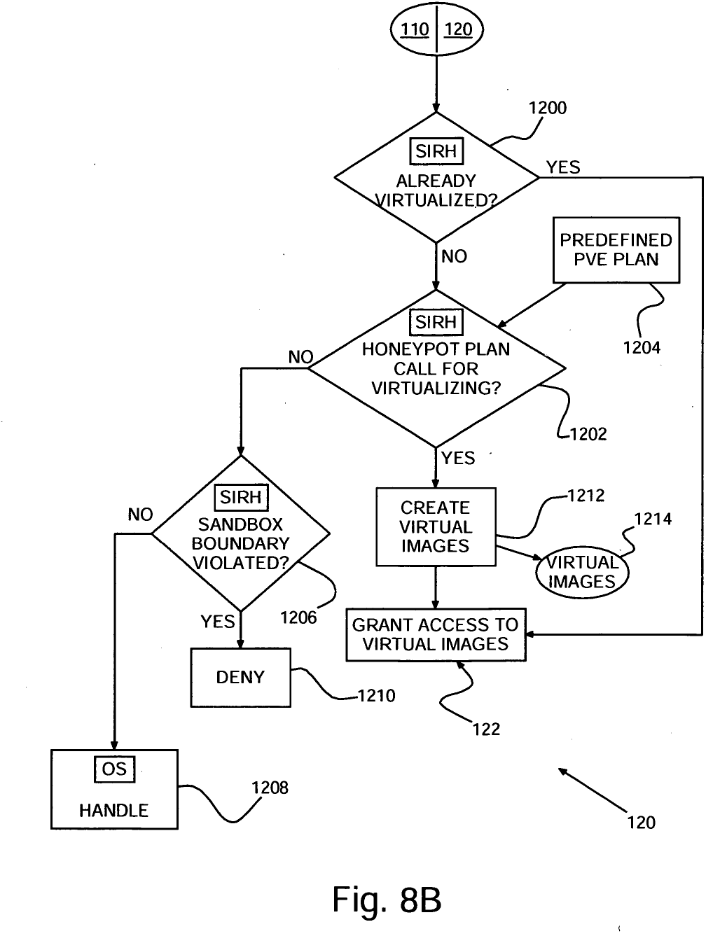

FIG. 8A shows an example of opening a dynamic honeypot, if necessary, in step 118 of FIG. 1 and FIG. 8B shows an example of providing virtualized resources to an application in a dynamic honeypot contained within a sandbox in steps 120 and 122. First in step 1180, the request from an application operating in a sandbox is checked to determine if it is a violation of the sandbox boundary. If not, in step 1182 the application handles the request normally. If in step 1180 the request is a violation of the sandbox boundary, then in step 1184 predefined honeypot plans 1186 are checked to determine if one is available. If not, in step 1188 the request is denied. Otherwise, in step 1190 a dynamic honeypot is constructed in the sandbox around the application according to the predefined plan 1186.

Once a dynamic honeypot is constructed or, if the application was already operating in the dynamic honeypot, resources may be virtualized. So, in step 1200 the SIRH 152 checks to determine whether the requested resources have already been virtualized. If not, in step 1202 the SIRH 152 checks the honeypot plan 1204 to determine whether the requested resources should be virtualized. If not, the SIRH 152 checks whether the request violates the sandbox boundary in step 1206 and, if not, allows the OS to handle the request in 1208. Otherwise, in step 1210 the SIRH 152 denies the request. If in step 1202, however, the SIRH 152 determines that the requested resources should be virtualized, then in step 1212 a virtual image 1214 is created of the requested resources. If it was determined in step 1200 that resources have already been virtualized, that image is used as virtualized image 1214. Finally in step 122 the SIRH 152 grants access to the virtualized image 1214.

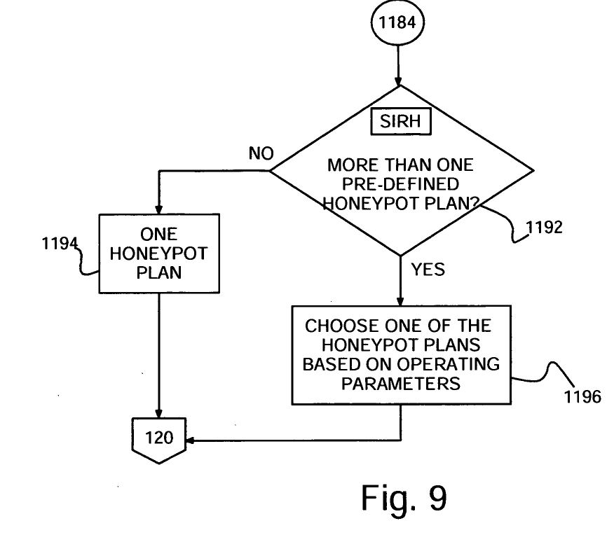

FIG. 9 shows an example of the step 1190 of constructing a dynamic honeypot in the sandbox around the application when more than one honeypot plan 1186 may be selected. In step 1192, predefined honeypot plans are checked to determine if more than one exist. If not, in step 1194, the single pre-defined plan is selected and passed to step 118. Otherwise, in step 1196, one of the available pre-defined honeypot plans is selected. Preferably, a honeypot plan is selected based on certain parameters that may include but are not limited to: environmental parameters such as time of day; attributes of the application such as the identity of the user on behalf of which the application is being executed; the intended usage of the application; and etc. The selected plan is passed to step 118.

Advantageously, a dynamic honeypot provides a realistic illusion to convince an attacker that the attack is successful and, thereafter luring the attacker to stay in the illusion, i.e., the dynamic honeypot. The honeypot can be dynamically provided because the SIRH 152 intercepts every call that the attacked application makes to access resources and the SIRH 152 has complete discretion to chose how to respond, such as granting access to a copy of the requested resources and etc. Similarly, the SIRH 152 may duplicate the image of the entire system (including the requested resources) onto another dedicated computer system or a VM. Further, although the dynamic honeypot is described as being implemented in a dedicated computer system or a VM, this is for example only and not intended as a limitation.

Further, once an application is contained in a dynamic honeypot, in a PVE or enclosed in a sandbox, the SIRH 152 can monitor application activity and collect data for subsequent use, e.g., for other IDS systems such as misuse detection and anomaly detection systems. Moreover, a typical misuse detection or anomaly detection system may be installed inside the dynamic honeypot, for example, to collect attack signatures for misuse detection or to collect characterize “normal” behavior pattern statistics for anomaly detection. Since the application is operating on virtualized resources in a dynamic honeypot within sandbox, the system is protected from an attack. The system is protected even though the attack has been allowed to progress normally under an illusion of operating covertly, e.g., in NE and even beyond the point where the attack might otherwise have been detected by a match to known attack signatures or statistics. Additionally, unlike prior misuse detection systems, a preferred embodiment system can detect previously unknown attacks with unknown signatures and so, does not require up-to-date signatures or statistical profiles to detect newly surfaced attacks.

Thus, the present invention combines a much improved low false alarm rate over both misuse detection systems and anomaly detection systems with the added protection of a sandbox IDS and a honeypot. These advantages are realized without incurring the inflexibility of the sandbox or the high overhead of a prior art resident honeypot that uses all of the normal computer resources. Accordingly, the present invention provides a low overhead approach that attracts attacks. The attacks can then proceed to attack the virtualized resources rather than the computer's resources, even as data is collected about the attacks.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A method of protecting a computer against attacks, said method comprising the steps of:
a) monitoring application requests for resources;
b) selectively virtualizing requested said resources; and
c) granting a requesting application access to virtualized said resources.

2. A method of protecting a computer as in claim 1, the step (a) of monitoring said application requests comprises:
i) determining whether said requesting application is operating in a sandbox; and
ii) creating a virtual copy of said requested resources for a selected said requesting application determined to be operating in a sandbox, access to said virtualized resources being granted within said sandbox.

3. A method of protecting a computer as in claim 1, wherein the step (b) of selectively virtualizing comprises determining whether said requested resources have been previously virtualized, access being granted to previously virtualized said requested resources.

4. A method of protecting a computer as in claim 1, wherein the step (b) of selectively virtualizing comprises the steps of:
i) determining whether a defined plan calls for virtualizing said requested resources; and, whenever said defined plan calls for virtualizing,
ii) creating a virtual image of said requested resources responsive to said defined plan.

5. A method of protecting a computer as in claim 4, wherein for each said defined plan that does not call for virtualizing said requested resources, the step (b) of selectively virtualizing further comprises the steps of:
iii) determining whether said request violates sandbox boundaries; and
iv) granting access to said requested resources for a determination that said request does not violate said sandbox boundaries.

6. A method of protecting a computer as in claim 5, wherein said defined plan is a personalized virtual environment (PVE) plan and when a plurality of PVE plans may be selected, one of said plurality of PVE plans is selected responsive to operating parameters.

7. A method of protecting a computer as in claim 6, wherein said operating parameters comprise:
the identity of said requesting application;
environmental parameters;
application attributes;
an intended usage for said requesting application; and
the identity of a computer system running said requesting application.

8. A method of protecting a computer as in claim 4, wherein for said requesting application determined operating in other than a personalized virtual environment, said method further comprising before the step (b) of selectively virtualizing resources:
b1) constructing a honeypot; and
b2) placing said requesting application in said honeypot, said requesting application being granted access to said virtualized resources in said honeypot.

9. A method of protecting a computer as in claim 8, wherein said pre-defined plan is a pre-defined honeypot plan and when said pre-defined honeypot plan does not call for virtualizing said requested resources, the step (b) of selectively virtualizing further comprises the steps of:
iii) determining whether said request violates sandbox boundaries; and
iv) granting access to said requested resources for a determination that said request does not violate said sandbox boundaries.

10. A method of protecting a computer as in claim 9, wherein when a plurality of pre-defined honeypot plans may be selected, one of said plurality of pre-defined honeypot plans is selected responsive to operating parameters.

11. A method of protecting a computer as in claim 10, wherein said operating parameters comprise:
environmental parameters;
application attributes; and
an intended usage for said requesting application.

12. A method of protecting a computer as in claim 8, before the step (a) of monitoring applications, said method further comprising the steps of:
a1) determining whether an application should be placed in a sandbox;
a2) erecting said sandbox; and
a3) starting said application in said sandbox.

13. A method of protecting a computer as in claim 12, wherein the step (a3) of starting said application comprises the steps of:
i) determining whether said application should be placed in a PVE;
ii) building said PVE; and
iii) starting said application in said PVE.

14. A computer system protected against external attacks, said computer system comprising:
processing means for processing applications;
an application interface interfacing said applications with system resources, said applications requesting system resources through said application interface;
an intrusion detector monitoring application requests and identifying ones of said application requests as being potential attacks;
a system resource virtualizer selectively virtualizing requested said system resources responsive to an identified potential attack; and
means for granting access to virtualized said resources to a requesting one of said applications, said requesting one operating on said virtualized resources, said system resources being protected from said identified potential attack.

15. A computer system as in claim 14, further comprising:
sandbox storage storing at least one defined sandbox plan;
personal virtualized environment (PVE) storage storing at least one defined PVE plan; and
honeypot storage storing at least one defined honeypot plan.

16. A computer system as in claim 15, wherein said intrusion detector erects a sandbox around selected starting said applications according to a stored said defined sandbox plan, unselected ones of said starting applications being started in native environment.

17. A computer system as in claim 16, further comprising a virtual machine monitor (VMM) selectively building a virtual machine (VM) and a PVE inside said VM according to a stored said defined PVE plan, one of said selected starting applications starting in said PVE contained in said erected sandbox.

18. A computer system as in claim 17, wherein said intrusion detector builds honeypots around selected suspected attacking applications according to stored defined honeypot plans.

19. A computer system as in claim 18, wherein for each requesting application in one said PVE, said means for granting access selectively creates said virtualized resources in said one PVE and grants access to selectively created said virtualized resources in said PVE responsive to said stored defined PVE plan.

20. A computer system as in claim 19, wherein said intrusion detector selectively denies access to system resources to ones of said requesting applications associated with request for resources violating sandbox boundaries.

21. A computer system as in claim 19, wherein for each requesting application in one said honeypot, said means for granting selectively access creates said virtualized resources in said one honeypot and grants access to selectively created said virtualized resources in said honeypot responsive to said stored defined honeypot plan.

22. A computer system as in claim 21, wherein said intrusion detector selectively denies access to system resources to ones of said requesting applications associated with request for resources violating sandbox boundaries.

23. A computer program product for protecting a computer system against external attacks, said computer program product comprising a computer usable medium having computer readable program code thereon, said computer readable program code comprising:
computer readable program code means for an application interface interfacing running applications with system resources, said running applications requesting system resources through said application interface;
computer readable program code means for monitoring application requests and identifying ones of said application requests as being potential attacks;
computer readable program code means for selectively virtualizing requested said resources responsive to identified potential attacks; and
computer readable program code means for granting access to virtualized said resources to a requesting one of said running applications, said requesting one operating on said virtualized resources, said system resources being protected from said identified potential attacks.

24. A computer program product as in claim 23, wherein said computer readable program code means for monitoring application requests comprises:
computer readable program code means for identifying starting applications as being susceptible to attacks;
computer readable program code means for erecting intrusion detection around identified susceptible said applications;
computer readable program code means for intercepting system calls from said identified susceptible applications and determining whether intercepted system calls indicate a potential attack; and
computer readable program code means for selecting whether to virtualize resources for each indicated said potential attack.

25. A computer program product as in claim 24, further comprising computer readable program code means for a virtual machine monitor (VMM) initiating virtual machines (VMs) in erected said intrusion detection, at least one said starting application being started in each initiated said virtual machines.

26. A computer program product as in claim 25, wherein said VMM creates a personalized virtual environment (PVE) for each said at least one starting application.

27. A computer program product as in claim 25, wherein said computer readable program code means for erecting intrusion detection around identified susceptible said applications comprises:
computer readable program code means for identifying starting applications as being susceptible to attacks;
computer readable program code means for erecting a sandbox around identified said starting applications;
computer readable program code means for intercepting system calls from said identified susceptible applications and determining whether intercepted system calls indicate a potential attack;
computer readable program code means for selectively building a honeypot responsive to indicated potential attacks, selected ones of said identified susceptible applications being placed in honeypots; and
computer readable program code means for selecting whether to virtualize resources for each indicated said potential attack, access being granted to virtualized said resources in a corresponding said sandbox.

28. A computer program product as in claim 27, further comprising:
computer readable program code means for providing at least one defined sandbox plan, each said sandbox being erected responsive to one said at least one defined sandbox plan;
computer readable program code means for providing at least one defined personal virtualized environment (PVE) plan, PVEs being selectively erected in one said sandbox responsive to one said at least one defined PVE plan; and
computer readable program code means for providing at least one defined honeypot plan, honeypots being selectively erected in one said sandbox responsive to one said at least one defined honeypot plan.

29. A computer program product as in claim 28, wherein said computer readable program code means for identifying starting applications starts ones of said starting applications in native environment, remaining said ones of said starting applications being identified as susceptible to attacks.

30. A computer program product as in claim 28, wherein said computer readable program code means for detecting intrusions selectively denies access to system resources to ones of said requesting applications associated with request for resources violating sandbox boundaries.
